(19) United States
(12) Patent Application Publication
(10) Pub. No.: US 2025/0306534 A1
(43) Pub. Date: Oct. 2, 2025

(54) Flip-Cover Protective Watch Case

(71) Applicant: Xuying Lei, Dongguan (CN)

(72) Inventor: Xuying Lei, Dongguan (CN)

(21) Appl. No.: 18/621,145

(22) Filed: Mar. 29, 2024

(51) Int. Cl. G04B 37/00

(52) U.S. Cl. CPC G04B 37/0025

(57) ABSTRACT

A flip-cover protective watch case, comprising: a case body and a cover body. The case body is equipped with a cavity. The case body has a pivot mechanism and a latch mechanism. One side of the cover body is rotatably connected to the case body through the pivot mechanism, and the inner surface of the other side of the cover body is equipped with a hook. The latch mechanism includes an elastic, with the pressing plate featuring a latch tongue. When an external force is applied to the pressing plate, pushing the pressing plate towards the interior of the case body, the latch tongue on the pressing plate disengages from the said hook, allowing the cover body to rotate through the pivot mechanism, thereby achieving the flip-opening of the watch case. This invention not only protects the watch core but also offers simple and convenient operation.

### FIELD OF THE INVENTION

The present invention pertains to the technical field of protective casings for watches, specifically relating to a flip-cover protective watch case.

### BACKGROUND OF THE INVENTION

As is well known, smartwatches are time-measuring devices that can be worn on the wrist. They typically consist of a watch core and a watch strap, where the watch core is the core component of the watch, incorporating a mechanical, electronic, or hybrid system capable of stable operation and time measurement.

Many people enjoy wearing watches while engaging in sports activities, such as running or playing sports, where the watch may be subjected to significant impacts and vibrations. Although the watch core is usually protected by an outer casing, the casings of current smartwatches are often made of resin or silicone materials, which can easily be damaged under external forces, leading to the watch core's casing and mirror surface being susceptible to collisions and scratches. To address this, a protective watch case specifically designed for smartwatches has been developed, which encases and protects the watch core. However, current protective watch cases, for ease of installation and screen viewing, do not have protective covers, which if included, would make it difficult to insert the watch core into the protective case. In response to this issue, the inventor has developed the following technical solutions through improvements.

### SUMMARY OF THE INVENTION

The objective of the present invention is to overcome the disadvantages in the current technology by proposing a flip-cover protective watch case, which provides comprehensive protection to the watch core through the cover, while the cover adopts a flip design, allowing for quick opening for easy assembly, replacement, and other operations of the watch core.

To achieve the above objective, the present invention provides the following technical solution: A flip-cover protective watch case comprising: a case body and a cover body. The case body has a cavity for placing the watch core, and the cover body is designed with a hollow-out for displaying the watch core. The case body is equipped with a pivot mechanism and a latch mechanism on opposite sides. One side of the cover body is rotatably connected to the case body through the pivot mechanism, and the inner surface of the other side of the cover body is provided with a hook that engages with the latch mechanism. The latch mechanism includes an elastic, extendable pressing plate that extends to the outside of the case body, and the pressing plate is equipped with a latch tongue that engages with the said hook. When an external force acts on the pressing plate, pushing the pressing plate to move inward towards the case body, the latch tongue on the pressing plate disengages from the said hook, allowing the cover body to rotate through the pivot mechanism, thereby achieving the flip-opening of the watch case.

Furthermore, in the technical solution mentioned above, the sides of the case body not equipped with the pivot mechanism and latch mechanism respectively have slots for the insertion of a watch strap, these slots communicating with the said cavity.

Moreover, the aforementioned technical solution includes a pivot mechanism comprising: a pivot base fixedly connected to the side wall of the case body, a shaft sleeve fixed on the side of the cover body, a pivot shaft, and a torsion spring. The pivot base, shaft sleeve, and torsion spring are sleeved on the pivot shaft, allowing the cover body to rotate relative to the case body around the pivot shaft, with the torsion spring providing a torsional force to open the cover body.

Additionally, the pivot base is fixedly connected inside a fixed slot on the side wall of the case body, secured by screws.

Furthermore, the mentioned technical solution includes a latch mechanism comprising: a pressing plate, a base, a cover plate, and a reset spring. A slide groove for installing the pressing plate is formed on the base, with the cover plate fixed on the base. The cover plate and base clamp and restrict the pressing plate within the slide groove; one end of the pressing plate extends out through the opening of the slide groove, and the reset spring installed in the slide groove provides a resetting force for the pressing plate.

Moreover, a protrusion is formed on the inside opposite the opening on the base, with a groove opposite the opening provided on the outer side of the protrusion, and card slots are respectively provided on both sides of the slide groove; the inner side of the pressing plate corresponding to the groove forms an upward extending latch tongue, and protrusions are formed on both sides of the pressing plate corresponding to the positions of the card slots; the cover plate is provided with a notch for avoiding the protrusion and the latch tongue; positioning holes are provided on both sides of the protrusion, one end of the reset spring is inserted into a positioning hole, and the other end of the reset spring abuts the inner wall of the pressing plate.

In addition, in the technical solution mentioned above, the side of the case body where the latch mechanism is installed is provided with an adjustment hole, and an adjustment module is installed at the adjustment hole. The adjustment module includes: an adjustment base fixed at the position of the adjustment hole, an adjustment knob mounted on the adjustment base, and an adjustment button.

Furthermore, the latch mechanism is fixedly connected to the adjustment base.

Moreover, a recess is formed above the side of the case body where the adjustment hole is provided, the latch mechanism is embedded in the recess, and fixed above the adjustment base.

Lastly, the bottom surface of the case body is provided with a bottom hole.

The present invention provides the following beneficial effects:

1. The flip-cover protective watch case proposed by this invention, compared to existing protective cases, allows for the insertion of the watch core into the case body by actuating the pressing plate to disengage the hook on the cover body from the latch tongue in the latch mechanism on the case body. The cover body then rotates through the pivot mechanism, achieving the flip-opening of the cover, thus allowing the watch to be placed inside the case body. The cover body can then be flipped back and secured, providing all-around protection for the watch core, preventing bumps and scratches during use. When it's necessary to open the cover body, a pressing force is reapplied to the pressing plate, allowing the cover to be opened through the pivot mechanism.

2. The flip-cover protective watch case proposed by this invention, in comparison to existing protective cases, features slots on the case body for inserting a watch strap, facilitating the replacement of the strap according to the user's needs, thus offering higher practicality.

3. The flip-cover protective watch case proposed by this invention, unlike existing protective cases, is equipped with an adjustment module. This module allows for the operation of corresponding knobs and buttons on the watch core through the adjustment knob and button on the module, facilitating the execution of various functions of the watch.

### DESCRIPTION OF THE DRAWINGS

FIG. 1 is a perspective view of the present invention;

FIG. 2 is a perspective view of the present invention from another angle;

FIG. 3 is a perspective view of the present invention with the cover body in the open state;

FIG. 4 is an exploded perspective view of the present invention;

FIG. 5 is an exploded perspective view of the present invention from another angle;

FIG. 6 is an exploded perspective view of the latch mechanism and adjustment module part of the present invention;

FIG. 7 is a top view of the latch mechanism of the present invention with the cover plate removed;

FIG. 8 is a cross-sectional view of the present invention;

FIG. 9 is an exploded perspective view of the present invention with the watch assembled;

FIG. 10 is a schematic view of the use of the present invention after assembly with a watch.

### DETAILED DESCRIPTION OF EMBODIMENTS

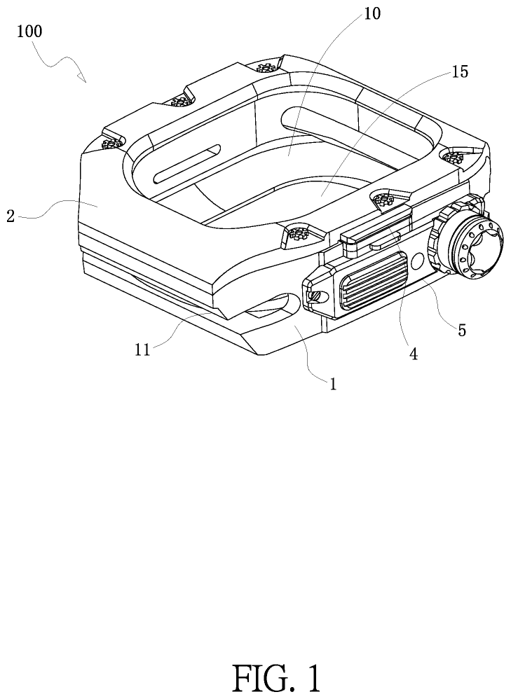

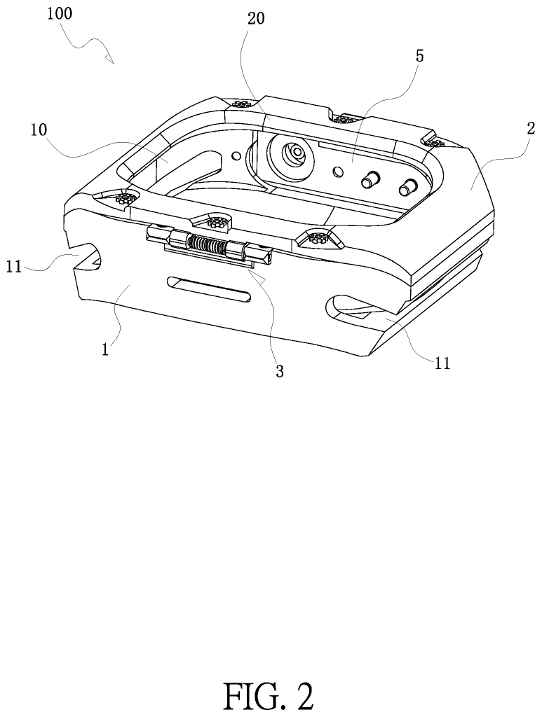

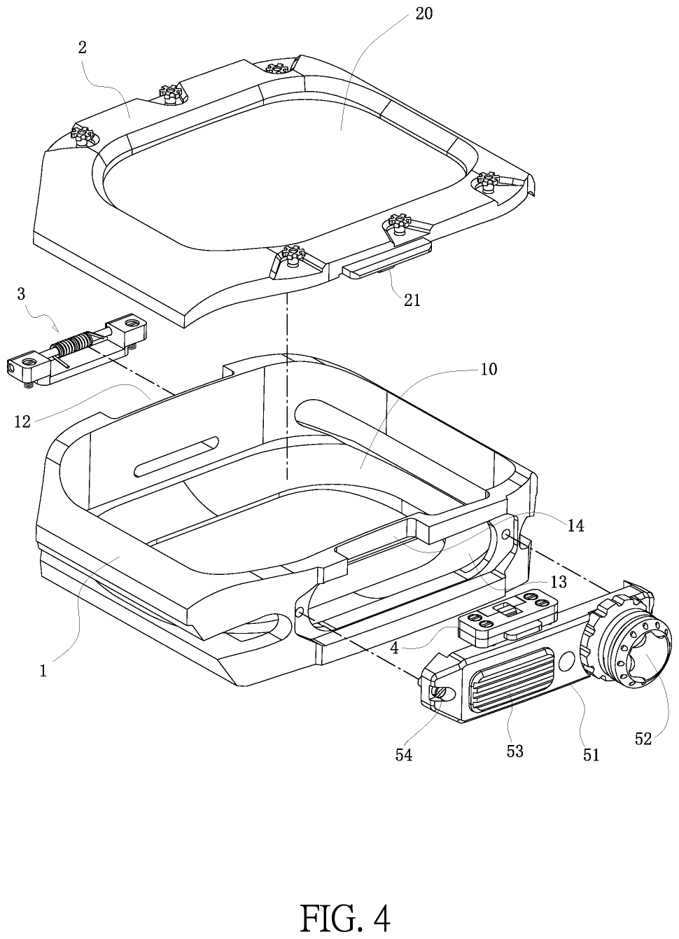

The following description of embodiments of the present invention is provided in conjunction with the accompanying drawings. As shown in FIGS. 1 to 4, and FIGS. 8 to 10, the present invention pertains to a flip-cover protective watch case, designated as 100. This watch case includes: a case body (1), a cover body (2), a pivot mechanism (3), a latch mechanism (4), and an adjustment module (5). The case body (1) has a cavity (10) for accommodating a watch core (6), with the pivot mechanism (3) and the latch mechanism (4) installed on opposite sides of the case body (1). The adjustment module (5) is mounted on the side of the case body (1), positioned below the latch mechanism (4). One side of the cover body (2) is rotatably connected to the case body (1) through the pivot mechanism (3), allowing the cover body (2) to rotate and secure the watch core (6) placed within the cavity (10).

The cavity (10) of the case body (1) is designed to be compatible with the shape of the watch core (6) to be placed, ensuring the watch core (6) is securely positioned within the cavity (10). Slots (11) for inserting a watch strap (7) are provided on the sides of the case body (1) not equipped with the pivot mechanism (3) and the latch mechanism (4), with these slots (11) communicating with the cavity (10). The watch strap (7) can extend through the slots (11) into the cavity (10) and connect with the strap interfaces set on the watch core (6), thus completing the assembly of the entire watch. The protective watch case (100) of the present invention solely protects the watch core (6) part and does not interfere with the normal wearing of the watch.

For some smartwatches, elements for monitoring the human heart rate are set on the bottom surface, requiring direct contact with the human body. Therefore, the bottom surface of the case body (1) is provided with bottom holes (15), allowing the watch core (6) of the smartwatch to function normally through the bottom holes (15).

The shape of the cover body (2) is compatible with the case body (1), with the cover body (2) having a hollow-out (20) for displaying the watch core (6). Users can directly observe the watch's screen through the hollow-out (20) area or perform corresponding touch operations. The cover body (2) not only protects the edges and corners of the watch core (6) but also prevents the watch core (6) from falling out of the cavity (10), enhancing the overall protection and safety.

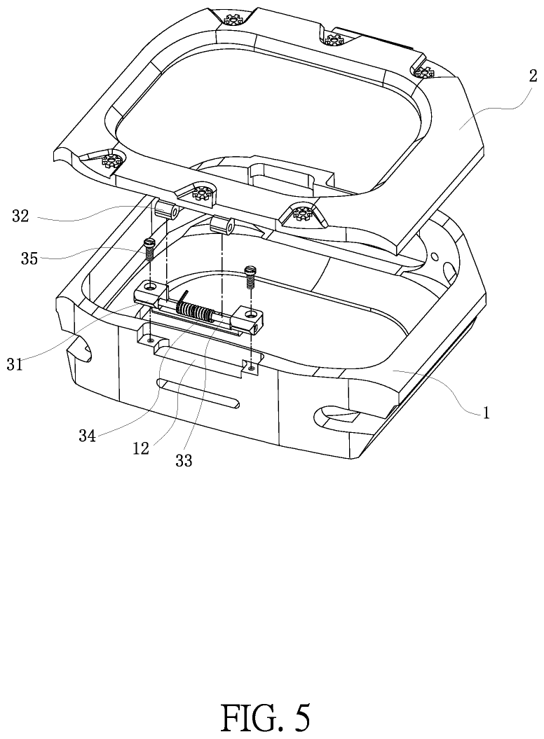

As illustrated in FIG. 5, the pivot mechanism (3) includes: a pivot base (31) fixedly connected to the side wall of the case body (1), a shaft sleeve (32) fixed on the side of the cover body (2), a pivot shaft (33), and a torsion spring (34). The pivot base (31), shaft sleeve (32), and torsion spring (34) are sleeved on the pivot shaft (33), allowing the cover body (2) to rotate relative to the case body (1) around the pivot shaft (33), with the torsion spring (34) providing a torsional force to open the cover body (2). The pivot base (31) is fixedly connected inside a fixed slot (12) on the side wall of the case body (1), with both ends of the pivot base (31) secured in the fixed slot (12) by screws (35), and the pivot shaft (33) passing through the pivot base (31), shaft sleeve (32), and torsion spring (34).

When the cover body (2) is in the closed state, the torsion spring (34) is in a compressed state, storing energy through its elastic deformation. Upon opening the cover body (2), the torsion spring (34) releases the stored energy, thus generating an automatic torsional force on the cover body (2), leading to the automatic opening of the cover body (2).

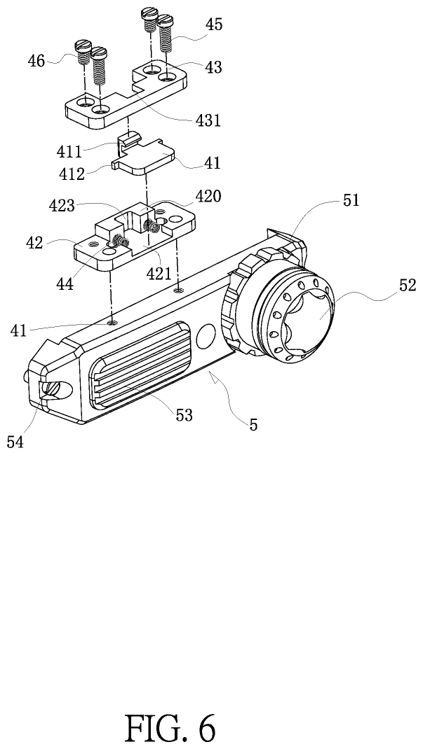

As illustrated in FIGS. 6 to 8, the latch mechanism (4) comprises: a pressing plate (41), a base (42), a cover plate (43), and a reset spring (44). A slide groove (421) for installing the pressing plate (41) is formed on the base (42), and the cover plate (43) is fastened to the base (42) using bolts (45, 46), clamping and restricting the pressing plate (41) within the slide groove (421). One end of the pressing plate (41) extends out through the opening (422) of the slide groove (421), and the reset spring (44) installed in the slide groove (421) provides a resetting force for the pressing plate.

Specifically, a protrusion (420) is formed on the inside opposite the opening (422) on the base (42), with a groove (423) opposite the opening (422) provided on the outer side of the protrusion (420). Card slots (424) are respectively provided on both sides of the slide groove (421). The inner side of the pressing plate (41) corresponding to the groove (423) forms an upward extending latch tongue (411), and protrusions (412) are formed on both sides of the pressing plate (41) corresponding to the positions of the card slots (424). The cover plate (43) is provided with a notch (431) for avoiding the protrusion (420) and the latch tongue (411). Positioning holes (4200) are provided on both sides of the protrusion (420), one end of the reset spring (44) is inserted into a positioning hole (4200), and the other end of the reset spring (44) abuts the inner wall of the pressing plate (41).

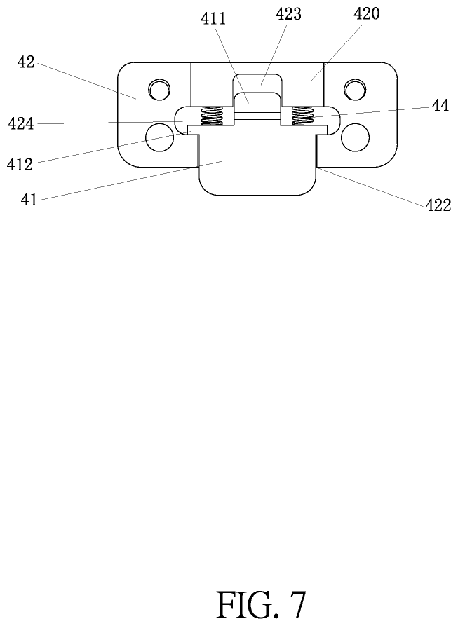

The shape of the pressing plate (41) corresponds to the entire shape of the slide groove (421). As shown in FIG. 7, when the pressing plate (41) is assembled, the latch tongue (411) of the pressing plate (41) is positioned within the groove (423), and the protrusions (412) on both sides are respectively positioned within the card slots (424) on both sides. The outer side of the pressing plate (41) extends out from the opening (422), facilitating easy pressing and activation by the user. The entire pressing plate (41) has a certain sliding allowance within the slide groove (421), which precisely enables the latch tongue (411) of the latch mechanism (4) to disengage from the hook (21) on the cover body (2).

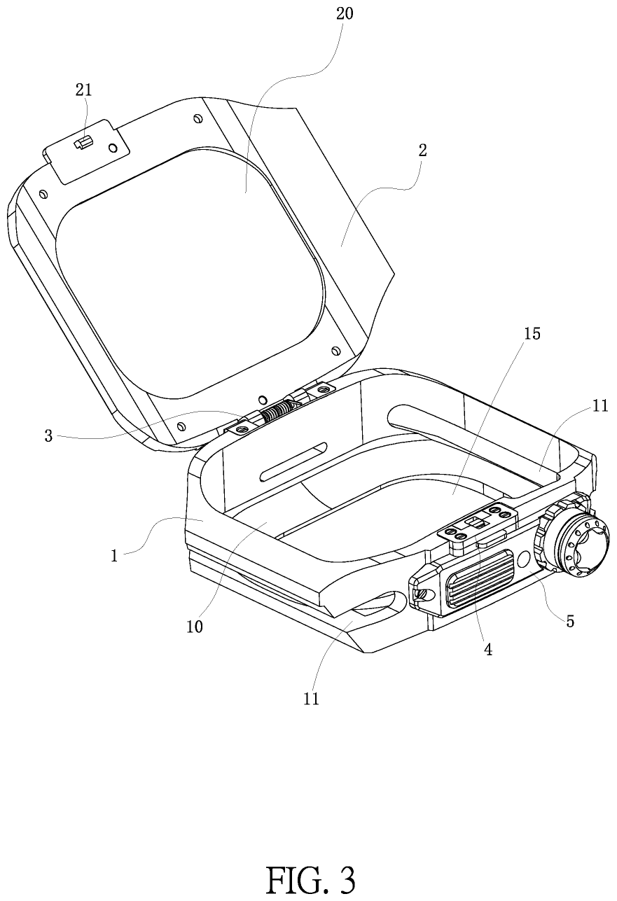

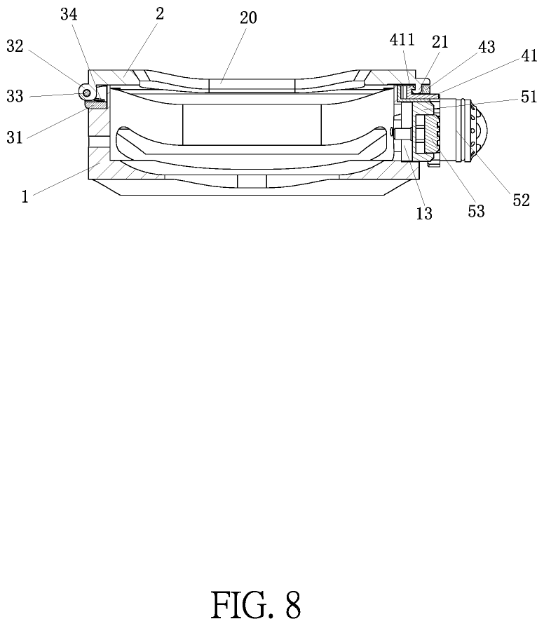

As shown in FIGS. 3 and 8, one side of the cover body (2) is rotatably connected to the case body (1) through the pivot mechanism (3), and the inner surface of the other side of the cover body (2) is equipped with a hook (21), which engages with the latch tongue (411) on the pressing plate (41). When the cover body (2) is closed over the case body (1), the hook (21) engages with the latch tongue (411), securing the cover body (2) in place and preventing it from automatically flipping open under the action of the torsion spring (34). When an external force is applied to the pressing plate (41), pushing it towards the interior of the case body (1), the pressing plate (41) slides within the slide groove (421), causing the latch tongue (411) on the pressing plate (41) to disengage from the hook (21). At this point, the cover body (2) rotates under the drive of the torsion spring (34) in the pivot mechanism (3), achieving the flip-opening of the watch case (100). To close the cover body (2), the user flips the cover body (2) back into place, where the hook (21), using its guiding surface, pushes the latch tongue (411) inward, with the pressing plate (41) moving inward against the force of the reset spring (44). Once the pressing plate (41) has moved inward sufficiently, allowing the hook (21) to pass over the latch tongue (411) and secure it into place, the pressing plate (41) resets under the force of the reset spring, engaging the latch tongue (411) with the hook (21) for a secure closure of the cover body (2) once again.

For some watches, their movements are equipped with knobs and buttons on the side for adjustments. To accommodate this feature, the present invention includes an adjustment module (5), which is conFIG.d as needed.

The adjustment module (5) is located below the latch mechanism (4). Specifically, the side of the case body (1) where the latch mechanism (4) is mounted has an adjustment hole (13), which communicates with the cavity (10) of the case body (1).

The adjustment module (5) includes: an adjustment base (51) fixed at the location of the adjustment hole (13), an adjustment knob (52), and an adjustment button (53) mounted on the adjustment base (51). The adjustment base (51) is secured in place at the adjustment hole (13) using fastening screws or rivets (54).

To facilitate the installation of the latch mechanism (4), the present invention has the latch mechanism (4) fixedly connected to the adjustment base (51). As illustrated in FIG. 6, a recess (14) is formed above the side of the case body (1) where the adjustment hole (13) is located, and the latch mechanism (4) is embedded into this recess (14) and fixed above the adjustment base (51). Specifically, the upper surface of the adjustment base (51) is provided with threaded holes (511) for a pair of bolts (45) that fasten the cover plate (43) and the base (42) to pass through and screw into the threaded holes (511), thus securing the latch mechanism (4) to the adjustment base (51).

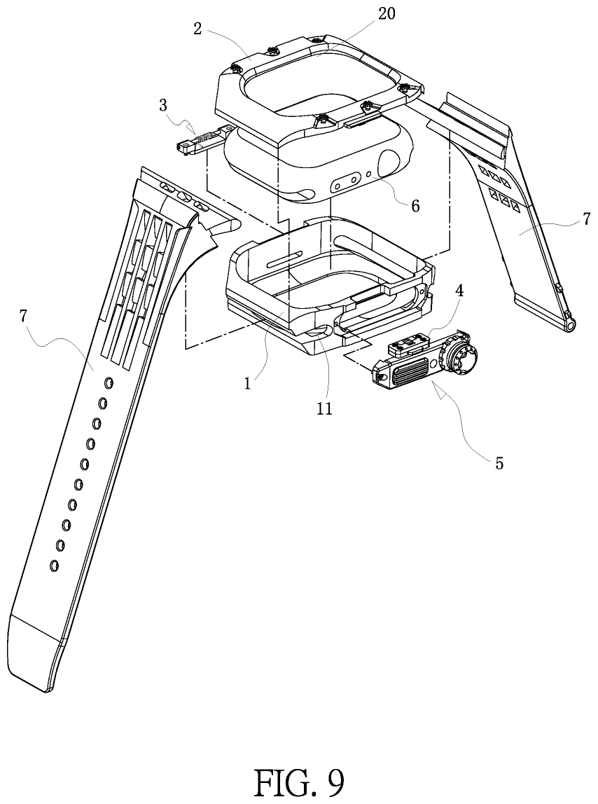

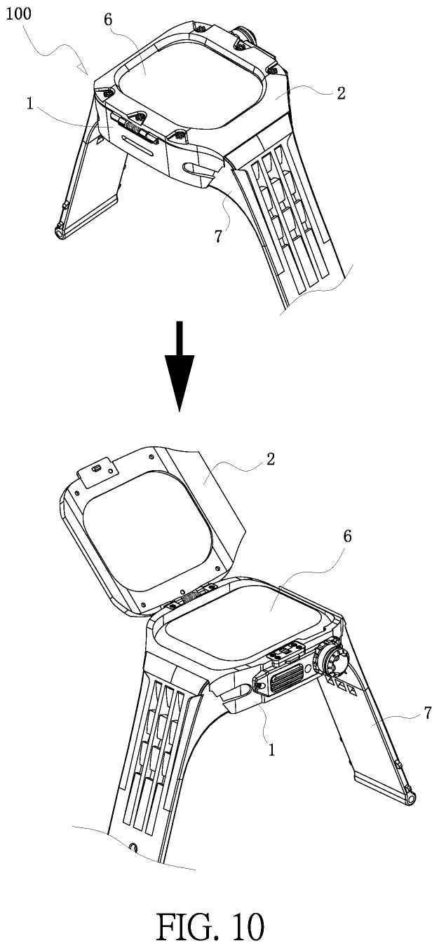

As shown in FIGS. 9 and 10, when using this utility model, first separate the watch core (6) and the watch strap (7). After opening the cover body (2), place the watch core (6) inside the cavity (10) of the case body (1), then close the cover body (2). Next, insert the watch strap (7) through the slot (11) and connect it to the interface on the watch core (6), thus completing the assembly.

To open the cover body (2), simply actuate the pressing plate (41), pushing it towards the interior of the case body (1). This action causes the latch tongue (411) on the pressing plate (41) to disengage from the hook (21), allowing the cover body (2) to rotate under the drive of the torsion spring (34) in the pivot mechanism (3), flipping open the cover body (2) and thus achieving the flip-opening of the watch case (100).

It should be noted that the foregoing descriptions are merely preferred embodiments of the invention and are not intended to limit the scope of the invention. Although the invention has been described in detail with reference to the foregoing embodiments, it will be evident to those skilled in the art that modifications and equivalent substitutions can be made to the described embodiments or parts of the technical features thereof. Any modifications, equivalent substitutions, improvements, etc., made within the spirit and principles of the invention should be included within the scope of the invention's protection.

I claim:

1. A flip-cover protective watch case, the watch case (100) comprising:
a case body (1) and a cover body (2),
wherein the case body (1) has a cavity (10) for placing a watch core (6), and the cover body (2) is provided with a hollow-out (20) for displaying the watch core (6),
the case body (1) is respectively equipped with a pivot mechanism (3) and a latch mechanism (4) on opposite sides, one side of the cover body (2) is rotatably connected to the case body (1) through the pivot mechanism (3), and an inner surface of the other side of the cover body (2) is provided with a hook (21) that engages with the latch mechanism (4);
the latch mechanism (4) comprises an elastic, extendable pressing plate (41) that extends to the outside of the case body (1), and the pressing plate (41) is provided with a latch tongue (411) that engages with the hook (21);
when an external force is applied to the pressing plate (41), pushing the pressing plate (41) to move inward towards the case body (1), the latch tongue (411) on the pressing plate (41) disengages from the hook (21), allowing the cover body (2) to rotate through the pivot mechanism (3), thus achieving the flip-opening of the watch case (100).

2. The flip-cover protective watch case according to claim 1, wherein the sides of the case body (1) that are not equipped with the pivot mechanism (3) and the latch mechanism (4) respectively have slots (11) for the insertion of a watch strap (7), the slots (11) communicating with the cavity (10).

3. The flip-cover protective watch case according to claim 1, wherein the pivot mechanism (3) includes a pivot base (31) fixedly connected to the side wall of the case body (1), a shaft sleeve (32) fixed on the side of the cover body (2), a pivot shaft (33), and a torsion spring (34), with the pivot base (31), shaft sleeve (32), and torsion spring (34) being sleeved on the pivot shaft (33), allowing the cover body (2) to rotate relative to the case body (1) around the pivot shaft (33), and the torsion spring (34) providing a torsional force for opening the cover body (2).

4. The flip-cover protective watch case according to claim 3, wherein the pivot base (31) is fixedly connected inside a fixed slot (12) on the side wall of the case body (1), and the pivot base (31) is fixed by screws (35).

5. The flip-cover protective watch case according to claim 1, wherein the latch mechanism (4) comprises a pressing plate (41), a base (42), a cover plate (43), and a reset spring (44);
a slide groove (421) for installing the pressing plate (41) is formed on the base (42), the cover plate (43) is fixed on the base (42), and the cover plate (43) and base (42) clamp and restrict the pressing plate (41) within the slide groove (421);
one end of the pressing plate (41) extends out through the opening (422) of the slide groove (421), and the reset spring (44) installed in the slide groove (421) provides a resetting force for the pressing plate.

6. The flip-cover protective watch case according to claim 5, wherein a protrusion (420) is formed on the inside opposite the opening (422) on the base (42), with a groove (423) opposite the opening (422) provided on the outer side of the protrusion (420), and card slots (424) are respectively provided on both sides of the slide groove (421);
the inner side of the pressing plate (41) corresponding to the groove (423) forms an upward extending latch tongue (411), and protrusions (412) are formed on both sides of the pressing plate (41) corresponding to the positions of the card slots (424);
the cover plate (43) is provided with a notch (431) for avoiding the protrusion (420) and the latch tongue (411);
positioning holes (4200) are provided on both sides of the protrusion (420), one end of the reset spring (44) is inserted into a positioning hole (4200), and the other end of the reset spring (44) abuts the inner wall of the pressing plate (41).

7. The flip-cover protective watch case according to claim 1, wherein the side of the case body (1) where the latch mechanism (4) is installed is provided with an adjustment hole (13), and an adjustment module (5) is installed at the adjustment hole (13), the adjustment module (5) comprising: an adjustment base (51) fixed at the position of the adjustment hole (13), an adjustment knob (52) mounted on the adjustment base (51), and an adjustment button (53).

8. The flip-cover protective watch case according to claim 7, wherein the latch mechanism (4) is fixedly connected to the adjustment base (51).

9. The flip-cover protective watch case according to claim 8, wherein a recess (14) is formed above the side of the case body (1) where the adjustment hole (13) is provided, the latch mechanism (4) is embedded in the recess (14), and fixed above the adjustment base (51).

10. The flip-cover protective watch case according to claim 1, wherein the bottom surface of the case body (1) is provided with a bottom hole (15).
